(19) United States
(12) Patent Application Publication
(10) Pub. No.: US 2019/0320626 A1
(43) Pub. Date: Oct. 24, 2019

(54) Oxygenation Device for Aquaculture Tank Group and Control Method

(71) Applicant: Jiangnan University, Wuxi (CN)

(72) Inventors: Zhiguo WANG, Wuxi (CN); Xiaoli LUAN, Wuxi (CN); Fei LIU, Wuxi (CN)

(21) Appl. No.: 16/405,052

(22) Filed: May 7, 2019

Related U.S. Application Data
(63) Continuation of application No. PCT/CN2018/089936, filed on Jun. 5, 2018.

(30) Foreign Application Priority Data
Apr. 20, 2018 (CN) 201810359554.9

(51) Int. Cl. A01K 63/04; C02F 1/72

(52) U.S. Cl. CPC A01K 63/042; C02F 1/72; C02F 2201/005; C02F 2209/42; C02F 2209/03

(57) ABSTRACT

The present invention discloses an oxygenation device for an aquaculture tank group and a control method, and belongs to the technical field of aquaculture equipment. The oxygenation device for the aquaculture tank group includes a controller, a speed regulator, a fan and a buffer tank which are successively connected; an outlet of the buffer tank is connected with a main gas guiding tube, the main gas guiding tube is branched into a plurality of branch gas guiding tubes, a tail end of each branch gas guiding tube is connected with an oxygenation hole, each oxygenation hole is placed in a corresponding aquaculture tank, each aquaculture tank is placed in a pond, automatic oxygenation control over numerous flowing water aquaculture tank groups may be realized, and oxygen supply of aquaculture tanks may remain stable automatically when a water level of a water area of the pond changes due to weather variations or human factors. Moreover, a use method of the device is simple, and after an aquaculture plan is established, oxygenation of each aquaculture tank only needs to be adjusted once. In addition, the device is low in cost, expensive meters such as an adjusting valve and a dissolved oxygen sensor are reduced, and the oxygenation device for the aquaculture tank group is easy to popularize actually.

### TECHNICAL FIELD

The present invention relates to an oxygenation device for an aquaculture tank group and a control method, and belongs to the technical field of aquaculture equipment.

### BACKGROUND

A flowing water aquaculture technology is a modern aquaculture technology, it solves a series of problems existing in traditional pond culture, for example, deterioration of water quality of aquaculture is caused due to excess of baits, labor costs are required for periodic change of water of a pond, and necessary drug dependence for preventing fishes from falling ill severally affects quality safety of aquatic products. According to flowing water aquaculture, a reservoir, a lake, a river, a mountain stream or a pond or the like is generally used as a water source, with the help of water level difference, drainage or closure facilities, water pumps and the like, water continuously flows through a fish pond, or drained water is purified and then is injected into the fish pond. Because water flow has effects of feeding dissolved oxygen and discharging excrements of the fishes, the quality of the water of the pond keeps good, and conditions are created for high-density intensive culture of the fishes. In all different flowing water aquaculture modes, aquaculture tanks are established in the pond, water pumps are used for generating flow, with the combination of some advanced sensors, water environment indexes such as water temperature, water quality, dissolved oxygen and baits are measured or controlled to simulate a flowing water living environment of the nature, and the mode is relatively easy to implement. The flowing water aquaculture with the aquaculture tanks has the advantages of small occupation area, high aquaculture density, high yield, high benefit, convenience in management and the like. However, in actual application, some technologies are not perfect, and oxygenation under a multi-aquaculture-tank mode is difficult.

In most of existing aquaculture oxygenation modes, oxygenation tubes are directly mounted in an aquaculture pond, then air is pumped into the oxygenation tubes through oxygenation pumps to increase oxygen in the aquaculture tanks, although the requirements of cultured living things on oxygen in water can be met, lots of oxygenation pumps are required, and the utilization efficiency is low. A patent CN202124528U discloses an oxygenation system for aquaculture, it proposes that a Roots blower is used for oxygenation, oxygenation for a plurality of aquaculture ponds is implemented through a main gas guiding tube connected with an air outlet of the Roots blower and through oxygenation devices which are connected with the main gas guiding tube through a plurality of branch gas guiding tubes, the purpose of simultaneously supplying oxygen for the multiple aquaculture ponds may be achieved, the aquaculture amount may be greatly increased, and costs are saved. However, when used for oxygenation for an aquaculture tank group, the scheme has some problems: 1) accurate control on the oxygenation amount of each aquaculture tank is difficult to achieve, for example, after the oxygenation amount of a certain aquaculture tank is adjusted, the adjusted oxygenation amount of the aquaculture tank may change again when another aquaculture tank is adjusted; 2) oxygenation is affected by the environment obviously, and if air pressure changes or the water level of a pond changes and the like, the original adjusted oxygenation amount no longer meets the requirement; and 3) the automation level is low, and workers often spend lots of time on adjustment of the oxygenation amount. In addition, even if the oxygenation amounts of all the aquaculture tanks are adjusted as needed, the oxygenation amounts need to be adjusted again if power outage occurs or an aquaculture scheme is changed.

### SUMMARY

In order to solve the problems, the present invention provides an oxygenation device for an aquaculture tank group firstly, and the oxygenation device for the aquaculture tank group includes a controller, a speed regulator, a fan and a buffer tank which are successively connected; an outlet of the buffer tank is connected with a main gas guiding tube, the main gas guiding tube is branched into a plurality of branch gas guiding tubes, a tail end of each branch gas guiding tube is connected with an oxygenation hole, each oxygenation hole is placed in a corresponding aquaculture tank, and each aquaculture tank is placed in a pond; and each branch gas guiding tube is serially connected with an internally piloted valve and a manually adjusted valve, opening and closing of the internally piloted valves are controlled by the controller, and opening degrees of the manually adjusted valves are adjusted manually.

In an embodiment of the present invention, a pressure detector is mounted in the buffer tank, is used for detecting pressure in the buffer tank, and transmits detection data to the controller.

In an embodiment of the present invention, the aquaculture tank group oxygenation device further includes a water level detector which is connected with the controller.

The present invention further provides a method for controlling oxygenation of an aquaculture tank group, wherein the method includes two links, in the first link, opening degrees of manually adjusted valves are adjusted according to an established aquaculture plan for each aquaculture tank and an oxygenation amount required for each aquaculture tank; and in the second link, automatically controlled oxygenation of each aquaculture tank is realized according to the established aquaculture plan.

The first link includes the following specific steps:

step S11: initializing the oxygenation device to ensure that all internally piloted valves are in a closed state;

step S12: starting a fan and a pressure automatic control procedure of a buffer tank, setting a setpoint of pressure control of the buffer tank as a rated pressure setpoint, and starting the pressure automatic control procedure;

step S13: judging pressure in the buffer tank by a pressure detector, and after the pressure in the buffer tank is stabilized at the rated pressure setpoint, opening the internally piloted valve on a certain branch gas guiding tube by an operator;

step S14: then manually adjusting the manually adjusted valve on the branch gas guiding tube, meanwhile measuring the content of oxygen in the aquaculture tank corresponding to the branch gas guiding tube, if the content of oxygen does not meet requirements, continuing adjusting the manually adjusted valve on the branch gas guiding tube, if the content of oxygen meets the requirements, fixing the opening degree of the manually adjusted valve on the branch gas guiding tube, and closing the internally piloted valve on the branch gas guiding tube so as to finish adjustment of the content of oxygen of the aquaculture tank; and

step S15: repeating steps S13-S14, adjusting the opening degrees of the manually adjusted valves on the rest branch gas guiding tubes to finish adjustment of the content of oxygen of the other aquaculture tanks until adjustment of the manually adjusted valves on all the branch gas guiding tubes is finished.

The second link includes the following specific steps:

step S21: in an initial state, enabling all the internally piloted valves to be in a closed state;

step S22: then starting the fan, setting the setpoint of pressure control of the buffer tank as the rated pressure setpoint and starting the pressure automatic control procedure;

step S23: opening the internally piloted valve on a certain branch gas guiding tube, properly increasing the pressure setpoint of the buffer tank, if an oxygenation hole of the branch gas guiding tube does not exhaust for oxygenation, continuing increasing the pressure setpoint of the buffer tank until the oxygenation hole of the branch gas guiding tube begins to exhaust for oxygenation, and then changing the setpoint of pressure control of the buffer tank into the rated pressure setpoint again; and

step S24: after the pressure of the buffer tank is stabilized, continuing adjusting the internally piloted valves on the other branch gas guiding tubes referring to steps S22 and S23 until all the internally piloted valves are open, and enabling the pressure setpoint of the buffer tank to enter a revision procedure.

In an embodiment of the present invention, the rated pressure setpoint of the buffer tank is set according to the oxygenation amounts required for the aquaculture tanks when a water level of a pond remains stationary.

In an embodiment of the present invention, the pressure setpoint of the buffer tank enters the revision procedure, and according to the revision procedure, the rated pressure setpoint is increased when a water level detector detects that a water level rises; and the rated pressure setpoint is reduced when the water level detector detects that the water level falls.

In an embodiment of the present invention, the setpoint of pressure control of the buffer tank in step S23 needs to be increased to such a degree that air pressure in a current branch gas guiding tube under operation offsets water pressure in the corresponding aquaculture tank, or may be increased to such a degree that the oxygenation hole of the current branch gas guiding tube begins to exhaust for oxygenation.

The oxygenation device for the aquaculture tank group and the control method which are provided by the present invention have the beneficial effects that: 1) the workload of manual adjustment on oxygenation amounts of multiple aquaculture tanks is reduced; 2) automatic oxygenation control on the multiple aquaculture tank groups may be realized; 3) the oxygen supply of the aquaculture tanks may be automatically adjusted when a water level of a pond changes due to weather variations or human factors; 4) a use method of the device is simple, oxygenation of each aquaculture tank only needs to be adjusted once after an aquaculture plan is established; and 5) the device is low in cost, expensive meters such as an adjusting valve and a dissolved oxygen sensor are reduced, and thus, the device is easy to popularize actually.

### BRIEF DESCRIPTION OF FIGURES

FIG. 1 is a schematic diagram of an integral structure of an aquaculture oxygenation device of the present invention;

FIG. 2 is a flow chart of an opening degree regulation procedure for manually adjusted valves of the present invention;

FIG. 3 is a flow chart of an oxygenation control procedure of aquaculture tanks under a self-control mode of the present invention.

Among the figures, 1—controller, 2—speed regulator, 3—fan, 4—buffer tank, 5—pressure detector, 6'water level detector, 7—aquaculture tank, 8—internally piloted valve, 9—manually adjusted valve, 10—main gas guiding tube, 11—branch gas guiding tube, and 12—oxygenation hole.

### DETAILED DESCRIPTION

An oxygenation device for an aquaculture tank group and a control method which are proposed by the present invention will be further described in detail in combination with accompanying drawings and specific embodiments. Advantages and features of the present invention will become apparent according to the following description and claims. It should be noted that the accompany drawings are illustrated in a quite simple mode and in an inaccurate proportion, and are only used for assisting in illustration of embodiments of the present invention conveniently and clearly.

### Example 1

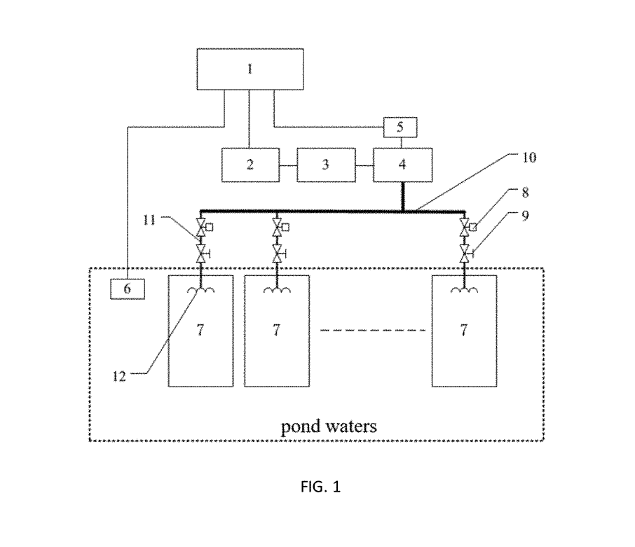

As shown in FIG. 1, an oxygenation device for an aquaculture tank group provided in Embodiment 1 of the present invention includes a controller 1, a speed regulator 2, a fan 3, a buffer tank 4, a pressure detector 5, a water level detector 6, internally piloted valves 8, manually adjusted valves 9, a main gas guiding tube 10, branch gas guiding tubes 11 and oxygenation holes 12.

The controller 1 is connected with the speed regulator 2, the speed regulator 2 is connected with the fan 3, and an outlet of the fan 3 is connected with the buffer tank 4. The controller 1 gives orders to the speed regulator 2 to change the rotating speed of the fan 3 so as to change discharge quantity of air, and thus, the air amount of the buffer tank 4 is changed. An outlet of the buffer tank 4 is connected with the main gas guiding tube 10, the main gas guiding tube 10 is branched into a plurality of branch gas guiding tubes 11, a tail end of each branch gas guiding tube 11 is connected with one oxygenation hole 12, each oxygenation hole 12 is positioned in the corresponding aquaculture tank 7, and each oxygenation hole 12 may discharge air for oxygenation on the corresponding aquaculture tank 7, and all the aquaculture tanks are placed in a pond. Each branch gas guiding tube 11 is connected with one internally piloted valve 8 and one manually adjusted valve 9, each internally piloted valve 8 is a switch valve, opening and closing of the internally piloted valves 8 are controlled by the controller 1, and opening degrees of the manually adjusted valves 9 are adjusted manually. The internally piloted valve 8 and the manually adjusted valve 9 on each branch gas guiding tube 11 are serially connected.

Particularly, the pressure detector 5 is mounted in the buffer tank 4, and is used for detecting change of pressure in the buffer tank 4, and data detected by the pressure detector 5 are input into the controller 1. The controller 1 is further connected with the water level detector 6, and the water level detector 6 is mounted in a water area of a pond in which the aquaculture tanks 7 are located, and is used for detecting change of a water level of the pond.

### Example 2

A method for controlling oxygenation of an aquaculture tank group provided by Embodiment 2 includes two links. In the first link, opening degrees of manually adjusted valves are adjusted according to an established aquaculture plan for each aquaculture tank and an oxygenation amount required for each aquaculture tank; and in the second link, automatically controlled oxygenation of each aquaculture tank is realized according to the established aquaculture plan under daily working conditions.

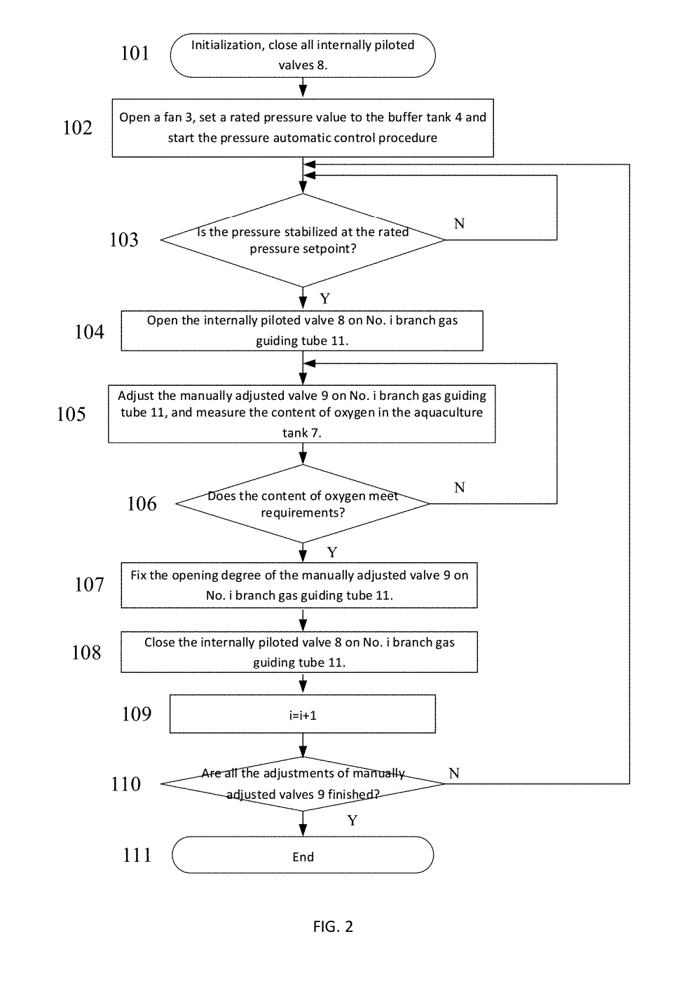

FIG. 2 shows a step flow chart of the first link. Firstly, the oxygenation device is initialized to ensure that all internally piloted valves 8 are in a closed state; a fan 3 and a pressure automatic control procedure of a buffer tank 4 are started, a setpoint of pressure control of the buffer tank 4 is set as the rated pressure setpoint, and the pressure automatic control procedure is started; and the pressure detector 5 judges the pressure in the buffer tank 4, after the pressure in the buffer tank 4 is stabilized at the rated pressure setpoint, an operator opens the internally piloted valve 8 on a certain branch gas guiding tube 11, then the manually adjusted valve 9 on the branch gas guiding tube 11 is adjusted manually, meanwhile, the content of oxygen in the corresponding aquaculture tank 7 is measured, if the content of oxygen does not meet requirements, the manually adjusted valve 9 is continuously adjusted, if the content of oxygen meets the requirements, the opening degree of the manually adjusted valve 9 on the branch gas guiding tube 11 is fixed, the internally piloted valve 8 on the branch gas guiding tube 11 is closed, and thus, adjustment on the content of oxygen of the aquaculture tank 7 is finished. According to the same steps, the opening degrees of the manually adjusted valves on the rest branch gas guiding tubes are adjusted, and the contents of oxygen of the other aquaculture tanks 7 are adjusted until adjustment on the manually adjusted valves on all the branch gas guiding tubes is finished.

Particularly, the rated pressure setpoint of the buffer tank 4 is set according to the oxygenation amount required for each aquaculture tank 7 when the water level of the water area of the pond remains stationary, fishes cultured in the different aquaculture tanks 7 may be different, and therefore, it should be guaranteed that under the rated pressure setpoint, the manually adjusted valves 9 on all the branch gas guiding tubes 11 are adjustable in upward and downward directions. Adjustment of the manually adjusted valve 9 of each aquaculture tank 7 is implemented independently, and when the internally piloted valve 8 and the manually adjusted valve 9 on the branch gas guiding tube 11 corresponding to a certain aquaculture tank 7 are operated, the internally piloted valves on the other branch gas guiding tubes are closed. Under the condition that the aquaculture plan is not changed, the opening degrees of the manually adjusted valves 9 remain stationary after adjustment of the manually adjusted valves 9 is finished.

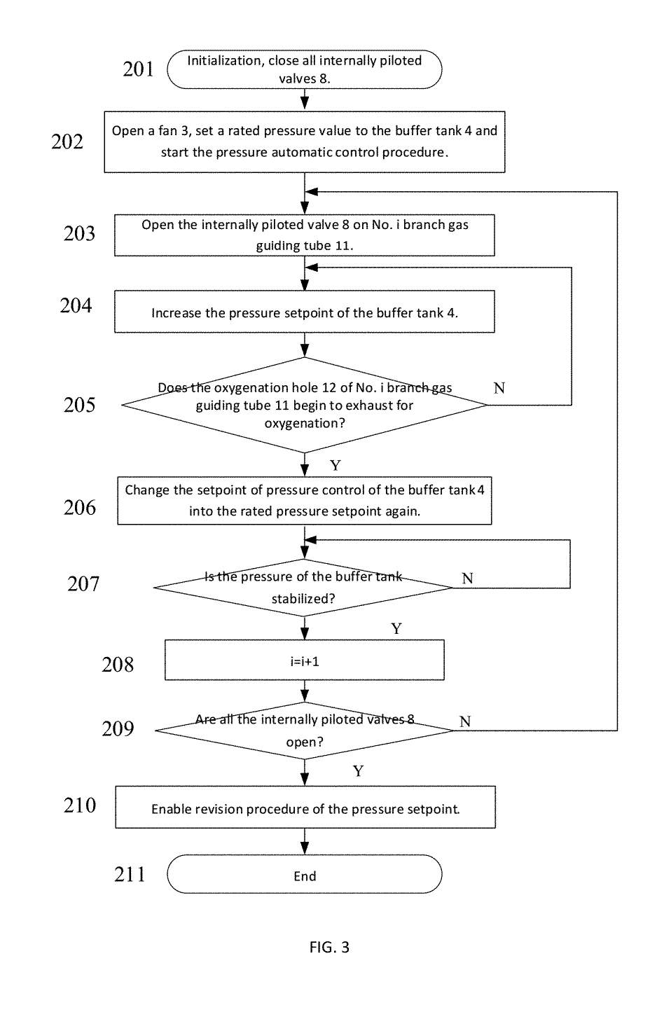

FIG. 3 shows a step flow chart of the second link. After adjustment of the opening degrees of all the manually adjusted valves 9 is finished in the first link, valve positions of the manually adjusted valves 9 remain stationary, automatic oxygenation of the aquaculture tanks 7 under daily working conditions is realized by adjusting the pressures of the internally piloted valves and the buffer tank, and it includes working steps of the whole oxygenation system after shut-down or power outage. Particularly, in an initial state, all the internally piloted valves are in a closed state; then the fan 3 is started, the setpoint of pressure control of the buffer tank 4 is set as the rated pressure setpoint, and the pressure automatic control procedure is started; the internally piloted valve 8 on a certain branch gas guiding tube 11 is opened, the pressure setpoint of the buffer tank 4 is increased properly, if the oxygenation hole 12 of the branch gas guiding tube 11 does not exhaust for oxygenation, the pressure setpoint of the buffer tank 4 is continuously increased until the oxygenation hole 12 of the branch gas guiding tube 11 begins to exhaust for oxygenation, and when the oxygenation hole 12 of the branch gas guiding tube 11 begins to exhaust for oxygenation, the setpoint of pressure control of the buffer tank 4 is changed into the rated pressure setpoint again. After the pressure of the buffer tank 4 is stabilized, the internally piloted valves on the other branch gas guiding tubes are continuously adjusted referring to the steps until all the internally piloted valves are open, and then the pressure setpoint of the buffer tank 4 enters a revision procedure. The revision procedure specifically includes that the rated pressure setpoint is increased when a water level detector 6 detects that a water level rises; and the rated pressure setpoint is reduced when the water level detector 6 detects that the water level falls.

Particularly, in the method for controlling oxygenation of the aquaculture tank group in the second link, the internally piloted valves on the different branch gas guiding tubes are opened one by one. The pressure setpoint of pressure control of the buffer tank 4 is firstly properly increased every time when the internally piloted valve 8 of a new branch gas guiding tube 11 begins to be adjusted, and then the pressure setpoint goes back to its original value; and the setpoint of pressure control of the buffer tank 4 needs to be increased to such a degree that air pressure in the current branch gas guiding tube 11 under operation offsets the water pressure in the corresponding aquaculture tank 7, or may be increased to such a degree that the oxygenation hole 12 of the current branch gas guiding tube 11 begins to exhaust for oxygenation.

According to the transformation experience of a certain project involving 29 aquaculture tanks in Suzhou, Jiangsu province, only a pressure sensor, a liquid level sensor and 29 switch valves need to be added on the basis of original aquaculture equipment when the device and method of the present invention are adopted. Compared with a scheme using a dissolved oxygen sensor and an adjusting valve, the method of the present invention has the characteristics that the cost is reduced by about 80%, and excessive maintenance is not required in a follow-up using process. Visibly, compared with a traditional oxygenation device, the device of the present invention has the characteristics that the increment of the cost for equipment is small, and the device is convenient to mount and use.

As for the specific using method, the oxygenation amounts of the 29 aquaculture tanks of an aquafarm in Suzhou, Jiangsu province are totally adjusted manually, because an oxygenation pipe of each tank is connected with a main oxygenation pipe, the tanks affect one other, after the oxygenation amount of a certain aquaculture tank is adjusted, the oxygenation amount of the originally adjusted aquaculture tank may change again when the oxygenation amounts of the other tanks are adjusted, and operators often spend several days on adjustment of the oxygenation amounts. Moreover, the oxygen supply of each tank may change again when the water level of a pond changes due to weather variations such as drought and rain. After the method of the present invention is adopted, it only needs a few hours to finish the adjustment of the 29 manually adjusted valves corresponding to the 29 aquaculture tanks, moreover, oxygenation control over each tank can be finished automatically every time when the device is started or restarted after power outage, human intervention is not required, and the workload of the operators is relieved to a large extent.

What is claimed is:

1. An oxygenation device for an aquaculture tank group, comprising a controller, a speed regulator, a fan and a buffer tank which are successively connected; wherein an outlet of the buffer tank is connected with a main gas guiding tube, the main gas guiding tube is branched into a plurality of branch gas guiding tubes, a tail end of each branch gas guiding tube is connected with an oxygenation hole, each oxygenation hole is placed in a corresponding aquaculture tank, and each aquaculture tank is placed in a pond; and wherein each branch gas guiding tube is serially connected with an internally piloted valve and a manually adjusted valve, opening and closing of the internally piloted valves are controlled by the controllers, and opening degrees of the manually adjusted valves are manually adjusted.

2. The oxygenation device for the aquaculture tank group according to claim 1, wherein a pressure detector mounted in the buffer tank is configured to detect pressure in the buffer tank and transmit detection data to the controller.

3. The oxygenation device for the aquaculture tank group according to claim 1, wherein the oxygenation device for the aquaculture tank group further comprises a water level detector which is connected with the controller.

4. A method for controlling oxygenation of an aquaculture tank group by using the oxygenation device according to claim 1, comprising a first link and a second link, wherein in the first link, opening degrees of manually adjusted valves are adjusted according to an established aquaculture plan for each aquaculture tank and an oxygenation amount required for each aquaculture tank; and wherein in the second link, automatically controlled oxygenation of each aquaculture tank is realized through a corresponding internally piloted valve according to the established aquaculture plan.

5. The method according to claim 4, wherein the first link comprises the following specific steps:
step S11: initializing the oxygenation device to ensure that all the internally piloted valves are in a closed state;
step S12: starting a fan and a pressure automatic control procedure of a buffer tank, setting a setpoint of pressure control of the buffer tank as a rated pressure setpoint, and starting the pressure automatic control procedure;
step S13: judging pressure in the buffer tank by a pressure detector, and after the pressure in the buffer tank is stabilized at the rated pressure setpoint, opening the internally piloted valve on a certain branch gas guiding tube by an operator;
step S14: then manually adjusting the manually adjusted valve on the branch gas guiding tube, meanwhile measuring content of oxygen in the aquaculture tank corresponding to the branch gas guiding tube, if the content of oxygen does not meet a requirement, continuing adjusting the manually adjusted valve on the branch gas guiding tube, if the content of oxygen meets the requirement, fixing the opening degree of the manually adjusted valve on the branch gas guiding tube, and closing the internally piloted valve on the branch gas guiding tube so as to finish adjustment of the content of oxygen of the aquaculture tank; and
step S15: repeating steps S13-S14, adjusting the opening degrees of the manually adjusted valves on the rest branch gas guiding tubes to finish adjustment of the content of oxygen of the other aquaculture tanks until adjustment on the manually adjusted valves on all the branch gas guiding tubes is finished.

6. The method according to claim 5, wherein the second link comprises the following steps:
step S21: in an initial state, enabling all the internally piloted valves to be in a closed state;
step S22: then starting the fan, setting the setpoint of pressure control of the buffer tank as a rated pressure setpoint and starting a pressure automatic control procedure;
step S23: opening the internally piloted valve on a certain branch gas guiding tube, properly increasing the pressure setpoint of the buffer tank, if an oxygenation hole of the branch gas guiding tube does not exhaust for oxygenation, continuing increasing the pressure setpoint of the buffer tank until the oxygenation hole of the branch gas guiding tube begins to exhaust for oxygenation, and then changing the setpoint of pressure control of the buffer tank into the rated pressure setpoint again; and
step S24: after the pressure of the buffer tank is stabilized, continuing adjusting the internally piloted valves on the other branch gas guiding tubes referring to steps S22 and S23 until all the internally piloted valves are opened, and enabling the pressure setpoint of the buffer tank to enter a revision procedure.

7. The method according to claim 6, wherein the rated pressure setpoint of the buffer tank is set according to the oxygenation amounts required for the aquaculture tanks when a water level of a pond remains stationary.

8. The method according to claim 6, wherein the pressure setpoint of the buffer tank enters the revision procedure, and according to the revision procedure, the rated pressure setpoint is increased when a water level detector detects that a water level rises; and wherein the rated pressure setpoint is reduced when the water level detector detects that the water level falls.

9. The method according to claim 6, wherein the setpoint of pressure control of the buffer tank in step S23 needs to be increased to such a degree that air pressure in a current branch gas guiding tube under operation offsets water pressure in the corresponding aquaculture tank, or may be increased to such a degree that the oxygenation hole of the current branch gas guiding tube begins to exhaust for oxygenation.
